(19) United States
(12) Patent Application Publication
(10) Pub. No.: US 2017/0306570 A1
(43) Pub. Date: Oct. 26, 2017

(54) System and Method for Recycling Asphalt through Radiant and Convection Heating and Simultaneous Gentle Tumbling

(71) Applicants: Francesco Crupi, Gulfport, FL (US); Hesham Ali, Davie, FL (US)

(72) Inventors: Francesco Crupi, Gulfport, FL (US); Hesham Ali, Davie, FL (US)

(21) Appl. No.: 15/136,461

(22) Filed: Apr. 22, 2016

(51) Int. Cl. E01C 19/10; F27B 19/02; F27B 9/24; B01F 15/06; F27B 19/04; B01F 15/02

(52) U.S. Cl. CPC E01C 19/1004; F27B 19/04; F27B 19/02; B01F 15/0229; F27B 9/2453; B01F 15/066; B01F 2015/062

(57) ABSTRACT

A system and method for recycling used asphalt material through convection heating and gentle tumbling recycles used asphalt material, such as reclaimed asphalt pavement, by uniformly and gradually applying radiant and convectional heating towards the used asphalt material. A radiant heating coil generates a controlled amount of radiant heat, at about 325 degrees, and up to 750 degrees Fahrenheit. At least one blower works to blow the radiant heat to the used asphalt material as convectional heat. An agitating conveyor simultaneously carries the used asphalt material while it is being heated. The agitating conveyor has a radiant heated conveyor floor that comprises depressions that work to agitate the used asphalt material. The uniform heating of the used asphalt material inhibits moisture from surging from the used asphalt material and maintains integrity of the subsequently formed rejuvenated asphalt. A rejuvenating chamber mixes the used asphalt material with a rejuvenating composition.

### FIELD OF THE INVENTION

The present invention relates generally to a system and method for recycling used asphalt material through convection heating and gentle tumbling. More so, a system and method works to uniformly and gradually heat used asphalt material by controllably providing a radiant heating coil that generates radiant heat and blowing through the radiant heating coil to create convectional heat towards the used asphalt material, while simultaneously carrying the used asphalt material along an agitating conveyor having a plurality of depressions that work to agitate and tumble the used asphalt material; whereby the convectional heat and the agitation enable uniform heating of the entire surface of the asphalt material; whereby the uniform heating of the used asphalt material inhibits moisture from surging from the used asphalt material and also helps to maintain the structural integrity of the subsequently formed rejuvenated asphalt.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

It is known that asphalt is a valuable material for use in a variety of applications. For example, one such application that utilizes asphalt is road construction. Once a road has been constructed, the natural climate and use of the roads requires ongoing maintenance. The road maintenance can be particularly difficult when it is being performed in remote locations, at odd hours and/or during cold weather.

Generally, asphalt-paved highways, driveways, avenues, and streets are recyclable. This is because asphalts are mainly composed of asphaltenes and maltenes. Asphalts are exposed to weathering, which provokes aging due to a decrease in the maltenes phase, produced by oxidation. The majority of existing roadways, both concrete and bituminous asphalt, undergo constant repair and surface overlay with new hot mix asphalt to achieve and maintain safe and comfortable high speed riding surfaces.

It is known that the milling of old road surfaces provides a number of advantages in preparing the old roadbed for resurfacing. Milling not only ensures a new, smooth and level base for the new hot mix overlay, but at the same time lowers the road bed height to maintain bridge deck clearances and curb and gutter depths. Grinding or milling is also beneficial in removing potholes, old cracks, joint seams, and ruts along with other surface damage that would quickly reappear in a new surface overlay if not repaired.

Reclaimed Asphalt Pavement (RAP) includes removed and/or reprocessed pavement materials containing asphalt and aggregates. These materials are generated when asphalt pavements are removed for reconstruction, resurfacing, or to obtain access to buried utilities. After removing the damaged asphalt from roads, asphalt recycling plants are used for recycling. Typically, asphalt recycling plants average 400 tons per hour to 600 tons per hour production ranges and 15% to 30% RAP can be injected into these plants.

Often, when attempting to inject cold wet RAP into hot mix plants, the existing processes rely almost entirely on super-heated virgin aggregates (600° to 900° Fahrenheit) to conductively transfer enough heat to the cold wet RAP for drying and heating all materials to a mixing temperature of 300° Fahrenheit. However, it is common that the sudden and violent steam expansion that is created when the super-hot aggregate (600° to 900° Fahrenheit) encounters the cold wet RAP instantly overloads exhaust system airflow capacity.

In one exemplary problem with excessive heating, asphalt when heated above a certain temperature tends to vaporize. The vapor mixes with dust released during material drying operations and with hot drying gases. The vapor condensates when cooled and needs to be filtered out together with the dust before the drying gases are released into the atmosphere. If the concentration of hydrocarbon becomes too great, state of the art filters tend to clog and downtime of the equipment results.

It is known that numerous problems occur when processing RAP into hot mix asphalt plants occurs. One problem is that the dryers must heat virgin aggregates to excessively high temperatures to dry and heat RAP and can therefore inflict heat damage, premature wear, and failure to the process. Another problem is that Plant productive capacity drops off dramatically when running RAP due to exhaust system and dryer burner overloads from RAP steam blockages within dryers.

Yet another problem is that batch Plants are limited as to RAP injection capacity due to fugitive emissions problems and potential plant damage due to violent steam explosions. Yet another problem is that RAP injection percentages are limited by aggregate temperatures for conductive heating. Heating aggregates above 600° Fahrenheit can cause the aggregate to fracture and allow mix gradations to drift out of specifications.

Other proposals have involved thermal processing and restoration of used asphalt paving materials after removal from road surfaces. The problem with these recycling methods is that they heat the used asphalt material too abruptly, causing surges of steam that damage the recycling system, and also degrade the structural integrity of the asphalt cement. Even though the above cited RAP recycling methods meet some of the needs of the market, a system and method that efficiently recycles used asphalt material, such as reclaimed asphalt pavement, with radiant and convectional heat, and then maintains the heat while rejuvenating the used asphalt material is still desired.

### SUMMARY OF THE INVENTION

The present invention is directed to a system and method that efficiently recycles used asphalt material, such as reclaimed asphalt pavement (RAP), through the use of radiant and convectional heat. The system and method provides a radiant heating coil that is configured to controllable generate radiant heat for heating used asphalt material, during one phase of the recycling process. At least one blower blows through the radiant heating coil to create the convectional heat that is blown towards the used asphalt material with at least one blower.

Specifically, the convectional heat radiates through the ambient air surrounding the used asphalt material. This gradual application of convectional heat enables controlled release of moisture from the used asphalt material. In one embodiment, the convectional heat percolates moisture out of the used asphalt material.

This convectional heating process is performed while simultaneously carrying the used asphalt material along an agitating conveyor. The agitating conveyor comprises a plurality of depressions that work to agitate and tumble the used asphalt material as it is being carries. At least one paddle urges the used asphalt material on and off the agitating conveyor. The ambient air surrounding the used asphalt material, the agitating conveyor, and the paddle are heated with radiant and convectional heat.

As discussed above, the agitating conveyor carries the used asphalt material throughout the convectional heating process. A conveyor heating member disposed along the length of the agitating conveyor radiates convectional heat on the used asphalt material as it is being carried. The convectional heat is also transferred to at least one paddle that is used to urge the used asphalt material onto the agitating conveyor. Further, the agitating conveyor is configured to tumble the individual aggregates of the used asphalt material so as to enable more uniform absorption of the convection heat. The convectional heat is emitted onto the used asphalt material, so as to maintain the used asphalt material at approximately 325°, and up to 325° Fahrenheit at the end of the heating process. The heating chamber is also heated up to 750° Fahrenheit.

In some embodiments, the system and method uniformly and gradually heats the used asphalt material within the confines of a heating chamber. The heating chamber is defined by an intake portion and an outlet portion. A radiant heating coil generates radiant and convectional heat in the heating chamber. The radiant heating coil is configured to apply a controlled amount of convectional heat, at a precise temperature level, with extended exposure time throughout the entire surface of the used asphalt material. Further, the radiant heating coil is adjustable to compensate for variables, such as released steam, and to achieve the final 325° Fahrenheit temperature.

At least one blower directs the generated heat from the radiant heating coil towards and around the used asphalt material. The blower may also be adjusted to increase the velocity and direction of the heated air flow. In one exemplary embodiment, the blower forces the convection heat at about between 10-50 miles per hour. Additionally, the blower may be configured to recover excess convectional heat from the heat chamber and reuse the convectional heat. Thus, the blower works to capture and recycle convectional heat in the ambient air of the heating chamber.

At least one paddle urges the used asphalt material onto the agitating conveyor at the intake portion of the heating chamber. The paddle also urges the used asphalt material off the agitating conveyor at the outlet portion of the chamber. The paddle is generally concave shaped to enhance the capacity to urge the used asphalt material onto the agitating conveyor. The paddle is heated to about 325° through convection heating. Those skilled in the art will recognize that since the paddle is the first component of the system to engage the used asphalt material, the heat cannot be excessive or the moisture will escape the used asphalt material in a violent manner.

The agitating conveyor carries the used asphalt material through the heating chamber during the entire heating process. The agitating conveyor comprises a plurality of depressions that work to agitate and manipulate the individual components, i.e., granules, of the used asphalt material. This constant movement of the individual components while receiving convectional heat enables uniform heating of the entire surface of the used asphalt material. Radiating and convectional heat is transferring from the floor as well.

In one embodiment, the agitating conveyor is heated to about 325°, and up to 750° Fahrenheit, through radiating and convection heating. The agitating conveyor may include a slotted conveyor belt having a conveyor floor that is covered with a plurality of concave dimples that tumble and manipulate the aggregates of the used asphalt material. This agitation allows the used asphalt material to be more uniformly heated.

The uniform heating of the used asphalt material inhibits moisture from surging from the used asphalt material, and also helps to maintain the structural integrity of the subsequently formed rejuvenated asphalt. In this manner, surges of steam do not disrupt the recycling process. Also, the used asphalt material is less likely to fracture from violent surges of moisture loss. In one exemplary embodiment, the used asphalt material is agitated and carried for about 6 minutes, and exposed to about 325° Fahrenheit convection heat between the intake portion and the outlet portion of the heating chamber.

Prior to entry into the intake portion of the heating chamber, a predetermined quantity of virgin aggregate mix is added to the used asphalt material. In one embodiment, about 10-15% of virgin aggregate mix is added to the total mixture. The virgin aggregate mix may include a mixture of dark bituminous pitch with sand and gravel that has never been used.

After discharge from the outlet portion of the heating chamber, the used asphalt material enters a rejuvenating chamber, such as a pug mill. The rejuvenating chamber is configured to mix the used asphalt material with a rejuvenating composition, so as to make the used asphalt material more supple and acceptable for use. In some embodiments, the rejuvenating chamber may include a liner that receives heat. The liner may be heated to about 325° Fahrenheit, so as to help maintain a constant temperature for the used asphalt material after leaving the heating chamber. By maintaining the used asphalt material at about 325° Fahrenheit in the rejuvenating chamber, the rejuvenating composition may be more efficaciously absorbed by the used asphalt material.

In one aspect, a system for recycling used asphalt material with convectional heat, the system comprising:

a heating chamber, the heating chamber comprising an intake portion and an outlet portion, the heating chamber configured to retain convectional heat;

an agitating conveyor, the agitating conveyor comprising an reception end and a discharge end, the agitating conveyor configured to enable carrying a used asphalt material from the intake portion to the outlet portion of the heating chamber, the agitating conveyor further comprising a plurality of depressions, the plurality of depressions configured to agitate and tumble the used asphalt material while being carried to the outlet portion of the heating chamber;

a conveyor heating member, the conveyor heating member disposed proximally to the agitating conveyor, the conveyor heating member configured to emit convectional heat of about 325 degrees Fahrenheit,

whereby the convectional heat from the conveyor heating member at least partially transfers to the used asphalt material;

a radiant heating coil, the radiant heating coil configured to radiate a generally uniform convectional heat of about 325° Fahrenheit;

at least one paddle, the at least one paddle configured to enable mechanical urging of the used asphalt material towards the reception end of the agitating conveyor;

at least one blower, the at least one blower configured to blow the generally uniform convectional heat radiated by the radiant heating coil towards the agitating conveyor and the at least one paddle,

whereby the convectional heat enables heating of the used asphalt material and the at least one paddle at about 325 degrees Fahrenheit,

whereby the used asphalt material is maintained at about 325 degrees Fahrenheit while in the heating chamber,

whereby the used asphalt material releases moisture in a controlled, uniform manner at about 325 degrees Fahrenheit; and

a rejuvenating chamber, the rejuvenating chamber configured to enable reception of the used asphalt material from the discharge end of the agitating conveyor, the rejuvenating chamber further configured to enable reception of a rejuvenating composition, the rejuvenating chamber comprising a liner, the liner configured to be heated to about 325 degrees Fahrenheit,

whereby the rejuvenating composition enhances the used asphalt material,

whereby maintaining the used asphalt material at about 325 degrees Fahrenheit enhances absorption of the rejuvenating composition.

In another aspect, the agitating conveyor comprises a slotted conveyor belt.

In another aspect, the plurality of depressions comprises a concave dimple.

In another aspect, the agitating conveyor is about four feet wide.

In another aspect, the rejuvenating chamber comprises a pug mill.

In another aspect, the convectional heat percolates moisture out of the used asphalt material.

A method for recycling used asphalt material with convectional heat, the method comprising:

providing a heating chamber for recycling a used asphalt material;

radiating convectional heat through the heating chamber with a radiant heating coil;

urging the used asphalt material into the heating chamber with at least one paddle;

blowing the convectional heat radiated by the radiant heating coil towards the at least one paddle;

heating the at least one paddle with the convectional heat radiating from the radiant heating coil;

carrying the used asphalt material through the heating chamber with an agitating conveyor;

blowing the convectional heat radiated by the radiant heating coil towards the agitating conveyor;

providing a conveyor heating member for radiating convectional heat;

heating the agitating conveyor with the radiated convectional heat from the conveyor heating member;

providing a rejuvenating chamber for rejuvenating the used asphalt material;

heating the rejuvenating chamber; and

mixing a rejuvenating composition with the used asphalt material.

One objective of the present invention is to gradually release steam from the used asphalt material (RAP) during recycling.

Yet another objective is to minimize fracturing of the RAP.

Yet another objective is to suppress violent surges of steam from RAP during heating.

Yet another objective is to take what is currently a RAP material that has no existing methodology to recycle it at a rate as close to 100% as possible.

Yet another objective is to reactivate the old asphalt binder (asphalt cement) contained in the RAP material and restore its original rheological properties.

Yet another objective is to re-coat uncoated aggregates contained in the RAP material.

Yet another objective is to enable mixture gradation control by adding calculated amounts of virgin aggregate mix having aggregates of of different sizes to achieve a design mixture gradation.

Yet another objective is to eliminate the moisture in the RAP at a controlled rate to keep the discharge of pollutants to a fraction of conventional plants.

Yet another objective is to reuse all of hot air created in the system over and over again this will reduce the excess heat discharge and burn 80% less fuel; whereby reusing the hot air in the system convection heat becomes very energy and fuel efficient.

Yet another objective is to heat the agitating conveyor, such that the the transfer of heat into the RAP is accelerated through radiant convection heat without damaging the volatile components in the asphalt cement.

Yet another objective is to eliminate any type of damaging flame or heat method that will further oxidize or burn the petroleum asphalt cement content in the RAP.

Yet another objective is to provide an inexpensive to manufacture RAP recycling system.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a diagram of an exemplary system for recycling used asphalt material in a heating chamber and carrying the used asphalt material along an exemplary agitating conveyor, in accordance with an embodiment of the present invention;

FIG. 2 illustrates a diagram of an exemplary system for recycling used asphalt material, shown in FIG. 1, with a radiant heating coil generating radiant and convectional heat towards used asphalt material on an agitating conveyor, in accordance with an embodiment of the present invention;

FIG. 3 illustrates a diagram of the system for recycling used asphalt material, shown in FIG. 1, with a radiant heating coil generating radiant and convectional heat, and the used asphalt material discharged into an exemplary rejuvenating chamber; and

FIGS. 4A and 4B illustrate flowchart diagrams of an exemplary method for recycling used asphalt material, in accordance with an embodiment of the present invention.

Like reference numerals refer to like parts throughout the various views of the drawings.

### DETAILED DESCRIPTION OF THE INVENTION

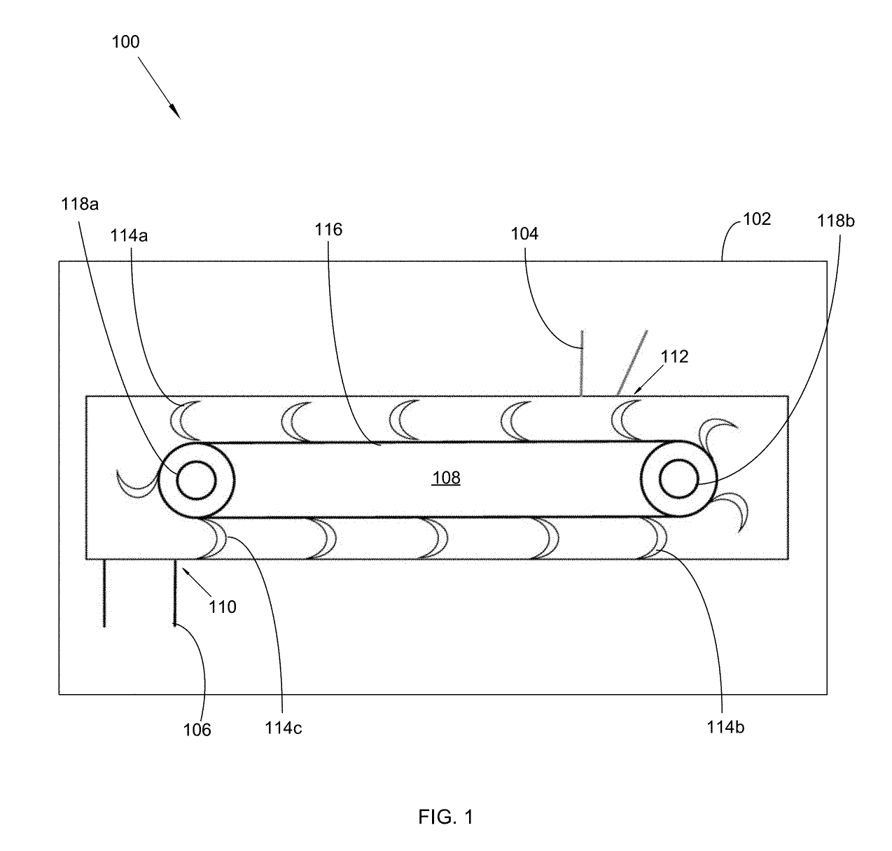

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

FIGS. 1-3 illustrate a system 100 that efficiently recycles used asphalt material 200 through the application of a gradual and uniform radiant and convectional heat 204, along with gentle tumbling of a used asphalt material 200. The system 100 is configured to uniformly and gradually heat used asphalt material 200 by providing a radiant heating coil 202 that generates a controlled amount of radiant heat, at about 325°, and up to 750° Fahrenheit. This gradual application of convectional heat enables controlled release of moisture from the used asphalt material 200. In one embodiment, the convectional heat percolates moisture out of the used asphalt material 200.

At least one blower works to blow the radiant heat from the radiant heating coil 202 towards the used asphalt material 200 as convectional heat. This heating process is performed while simultaneously carrying the used asphalt material 200 along an agitating conveyor 108 having a plurality of depressions that work to agitate and tumble the used asphalt material 200. The agitating conveyor 108 is heated through at least one conveyor heating member 206a, 206b, 206c that generates radiant and convectional heat.

At least one paddle 114a, 114b, 114c urges the used asphalt material 200 onto the agitating conveyor 108. The paddle 114a, 114b, 114c is also heated through convectional heat 204 by the radiant heating coil 202 and/or the conveyor heating member 206a, 206b, 206c. In this manner, uniform heating of the entire surface of the used asphalt material 200 is achieved.

The used asphalt material 200 may include, without limitation, reclaimed asphalt pavement (RAP), asphalt cement, and roof tiles. In some embodiments, the system 100 may include a heating chamber 102 where a substantial amount of the recycling occurs. The heating chamber 102 is configured to retain, radiate, and reuse the radiant and convectional heat 204 generated by a radiant heating coil 202 and blown towards the used asphalt material 200 with at least one blower 208 to create the convectional and radiant heat on the used asphalt material 200. The heating chamber 102 is also where the at least one paddle 114a, 114b, 114c operates.

In some embodiments, the system 100 employs a radiant heating coil 202 configured to apply about 325° Fahrenheit, and up to 750° Fahrenheit, of radiant and convectional heat 204 to the used asphalt material 200 during a heating phase of the recycling process. The convectional heat 204 from the radiant heating coil 202 radiates through the ambient air surrounding the used asphalt material 200.

The convectional heat 204 also permeates an agitating conveyer 108 on which the used asphalt material 200 is carried. Furthermore, the convectional heat 204 also permeates at least one paddle 114a, 114b, 114c that urges the used asphalt material 200 onto the agitating conveyor 108. In this manner, the used asphalt material 200 is constantly exposed to radiant and convectional heat 204 at about 325° Fahrenheit, and up to 750° Fahrenheit.

Further, the agitating conveyor 108 is configured to tumble the individual components of the used asphalt material 200 so as to enable the granules and components to more efficaciously absorb the convectional heat 204 in a uniform manner. Thus, the convectional heat 204 is emitted onto the used asphalt material 200, so as to maintain the used asphalt material 200 at approximately 325° Fahrenheit, and up to 750° Fahrenheit at the end of the convectional heating process. In this manner, the ambient temperature and trapped moisture in the used asphalt material 200 are released slowly and in a controlled manner.

In one embodiment, the used asphalt material 200 is RAP, which consists of asphalt cement. Though in other embodiments, the used asphalt material 200 consists of roof shingles and asphalt byproducts used for roofing. In other embodiments, the used asphalt material 200 includes asphalt based materials after they have been removed from road surfaces by milling, grinding or ripping. In any case, the used asphalt material comprises asphalt cement.

Those skilled in the art will recognize that asphalt cement is volatile, especially when heated suddenly by a torch or heat blaster. The purpose of the present invention is to avoid exceeding a temperature where the asphalt cement or other volatile components in the used asphalt material 200 are burned or reach a dangerous flash point. Thus, the system 100 uses a non-direct flame (radiant and convectional heat 204) to recycle the used asphalt material 200, rather than direct or strong heat.

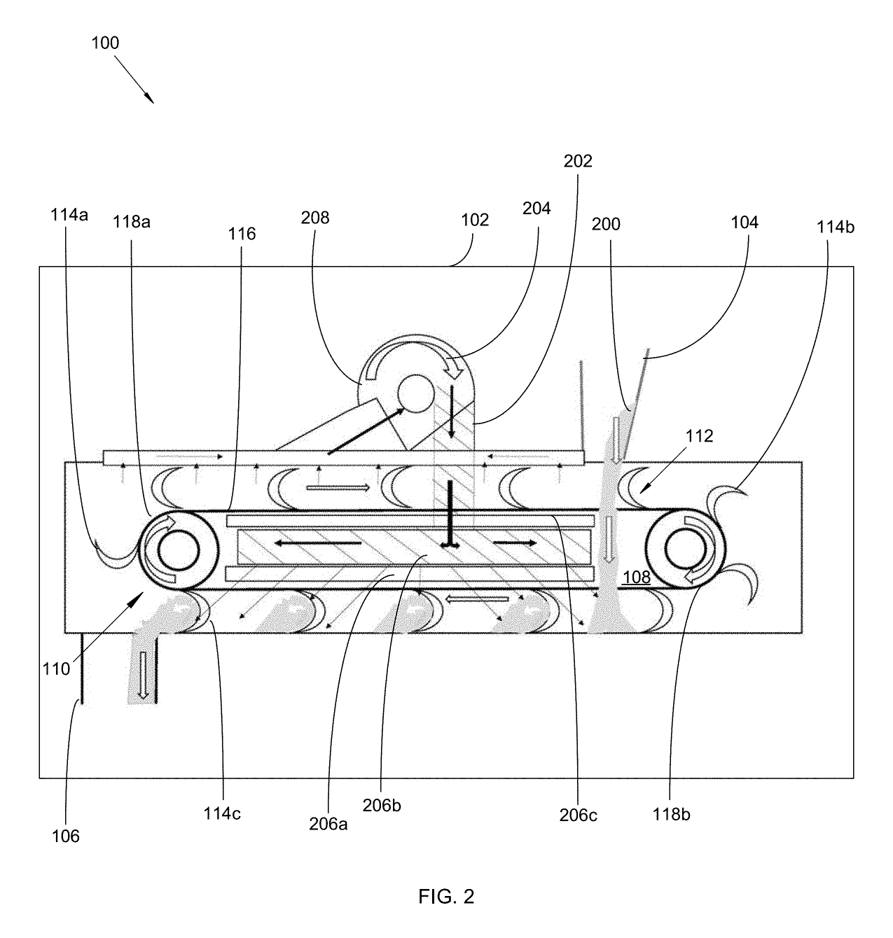

As referenced in FIG. 1, the system 100 is configured to uniformly and gradually heat the used asphalt material 200 in the heating chamber 102. The heating chamber 102 may be insulated and designed in such a manner that convectional heat 204 is conserved, radiated, and reused efficiently. For example, the heating chamber 102 may include an insulated, closed vessel that retains the convectional heat 204 and has an exhaust to regulate the release of excess heat. In one embodiment, the heating chamber 102 comprises an intake portion 104 and an outlet portion 106. The intake portion 104 loads the used asphalt material 200, virgin aggregate mix 300, and fine granules 302 onto the agitating conveyor 108, as shown in FIG. 2. The outlet portion 106 discharges the heated used asphalt material into a rejuvenating and mixing chamber 304, as described below.

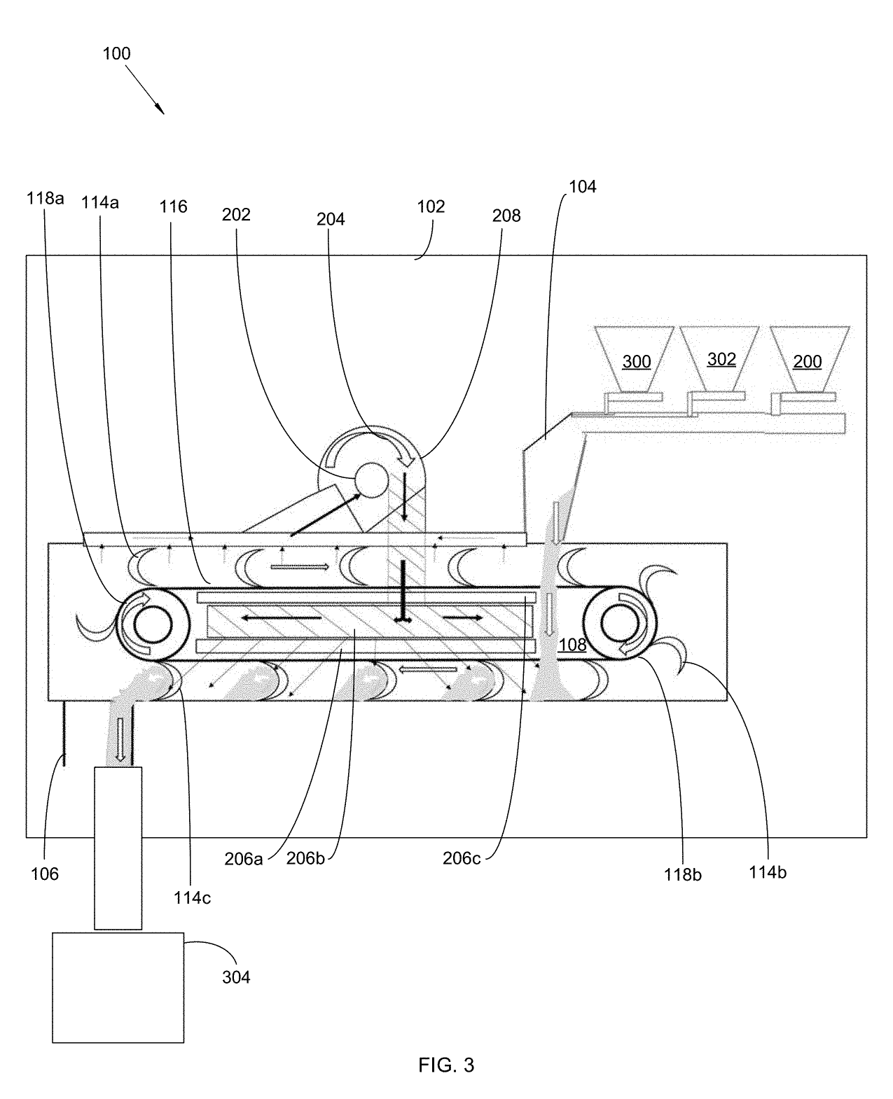

Looking now at FIG. 3, prior to loading of the used asphalt material 200 into the intake portion 104 of the heating chamber 102, a predetermined quantity of virgin aggregate mix 300 and fine granules 302, i.e., sand and granules, may be added to the used asphalt material 200. In one exemplary embodiment, the virgin aggregate mix 300 and fine granules 302 includes a mixture of virgin asphalt, sand, and gravel. The virgin aggregate mix 300 may also include a mixture of dark bituminous pitch with sand and gravel that has never been used. In one embodiment, about 10-15% of the virgin aggregate mix 300 and fine granules 302 is added to the used asphalt material 200. However it is significant to note that the virgin aggregate mix 300 and fine granules 302 may be added, but are not required depending on the mix engineering and lab results.

As FIG. 2 shows, a radiant heating coil 202 generates the radiant and convectional heat 204 throughout the heating chamber 102. The radiant heating coil 202 is configured to apply a controlled amount of radiant and convectional heat 204, at a precise temperature level, with extended exposure time throughout the entire surface of the used asphalt material 200. Further, the radiant heating coil 202 is adjustable to compensate for variables, such as released steam from the used asphalt material 200, so as to achieve the final desired 325° Fahrenheit temperature for the used asphalt material 200.

The uniform heating of the used asphalt material 200 by the radiant heating coil 202 helps to inhibit moisture from surging out of the used asphalt material 200. In this manner, violent surges of steam do not disrupt the recycling process or damage components of the heating chamber 102. The uniform, gradual convectional heating also helps to maintain the structural integrity of the subsequently formed rejuvenated asphalt since the used asphalt material 200 is less likely to fracture from violent surges of moisture loss.

Looking back at FIG. 2, at least one blower 208 is configured to blow the convectional heat 204 from the radiant heating coil 202 towards, and around the used asphalt material 200. In some embodiments, the blower 208 may be disposed in a spaced-apart relationship directly over, and along the sides of the agitating conveyor 108. The velocity of the heated air flow from the blower 208 may be adjusted. In one embodiment, the blower 208 forces the radiant and convectional heat 204 between 10-50 miles per hour. The direction of the blower 208 over the used asphalt material 200 may also be adjusted.

Additionally, the blower 208 is configured to recover excess heat that accumulates in the heating chamber 102, so as to reuse the heat. The capacity of the blower 208 to repetitively reuse a substantial amount of the convectional heated air that is created in the heating chamber 102 helps to reduce the excess heat discharge, and also allows the radiant heating coil 202 to burn about 80% less fuel.

Thus, reusing the convectional heated air in the heating chamber 102 enhances energy and fuel efficiency for the system 100. In one embodiment, the blower 208 may suck in proximal hot air for capturing the convectional heated air. The shapes and dimensions of the blower are configured to facilitate intake of excess convectional heat for recapturing. The convectional heat may then be redirected towards the used asphalt material 200 with the same blower.

As FIG. 2 illustrates, at least one paddle 114a, 114b, 114c urges the used asphalt material 200 onto an agitating conveyor 108 at the intake portion 104 of the heating chamber 102. In one embodiment, about ninety paddle 114a, 114b, 114c s revolve around the agitating conveyor 108. Each paddle 114a, 114b, 114c carries a predetermined quantity of used asphalt material 200 to a discharge end 110 of the agitating conveyor 108 before returning to load additional used asphalt material 200 at a reception end 112 to repeat the process.

While urging the used asphalt material 200 onto the agitating conveyor 108, the paddle 114a, 114b, 114c is heated to about 325° through convectional heating from the radiant heating coil 202, or in some embodiments, independent paddle convectional heaters. In yet another embodiment, the paddle 114a, 114b, 114c is heated with electric radiant and convectional heat 204 while urging the used asphalt material 200 onto the agitating conveyor 108. Those skilled in the art will recognize that since the paddle 114a, 114b, 114c is the first component of the system 100 to engage the used asphalt material 200, the convectional heat 204 cannot be excessive, or moisture may escape the used asphalt material 200 in a violent manner. Thus the paddle 114a, 114b, 114c is gradually heated and monitored to avoid excessive heating.

In one exemplary embodiment, the agitating conveyor 108 rotatably carries the used asphalt material 200 from the intake portion 104 to the outlet portion 106 of the heating chamber 102. A chain 116 may operatively attach to the agitating conveyor 108 to pull the agitating conveyor 108 in the direction from a reception end 112 to a discharge end 110 of the agitating conveyor 108. At least one chain drive sprocket 118a, 118b drives the chain 116. Though in other embodiments, additional conveying mechanisms known in the art may be used.

As the paddle 114a, 114b, 114c urges the used asphalt material 200 onto the reception end 112, or even in a middle section of the agitating conveyor 108, the used asphalt material 200 is carried to the discharge end 110 of the agitating conveyor 108 for unloading. In one embodiment, the agitating conveyor 108 comprises a slotted conveyor belt. In another embodiment, the agitating conveyor 108 is about four feet wide, so as to spread the used asphalt material 200 evenly.

While carrying the used asphalt material 200, the unique configuration of the agitating conveyor 108 works to tumble and manipulate the used asphalt material 200 as it is being heated. The agitating conveyor 108 may include a slotted conveyor belt having a surface covered with a plurality of concave dimples. In one embodiment, agitating conveyor 108 is about 4 feet wide. In some embodiments, the agitating conveyor 108 may include a conveyor floor having a plurality of depressions that work to agitate and manipulate the individual components, i.e., granules, of the used asphalt material 200. In one embodiment, the plurality of depressions comprises a concave dimple.

In one exemplary embodiment, the used asphalt material 200 is tumbled and agitated while being carried for about 6 minutes, and being exposed to about 325° Fahrenheit convectional heat 204 between the intake portion 104 and the outlet portion 106 of the heating chamber 102. However, in other embodiments, the radiant and convectional heat 204 may gradually rise to about 750° Fahrenheit as the used asphalt material 200 is carried along the agitating conveyor 108.

In one exemplary embodiment, the plurality of depressions are concave-shaped drag flights. The drag flights are attached to the drag chain 116 in a manner that forces the used asphalt material 200 to flow and tumble from the reception end 112 of the agitating conveyor 108 floor to the discharge end 110, or top of the flight as the flight is pulled through the agitating conveyor 108. In one embodiment, the concave flight blades are about 12″ high. Thus in one exemplary use, aggregates of the heated used asphalt material 200 tumble directly in front of the convex paddle flights as the paddle flights are dragged from the reception end 112 to the discharge end 110 of the agitating conveyor 108.

As discussed above, the agitating conveyor 108 includes a conveyor floor. The entire length of the conveyor floor is heated with electric radiant and convectional heat 204 that transfers convectional heat 204 from the conveyor floor into the used asphalt material 200. In one embodiment, a conveyor heating member 206a, 206b, 206c is disposed along the length of the agitating conveyor 108. The conveyor heating member 206a, 206b, 206c is configured to emit this radiant and convectional heat 204 of about 325° Fahrenheit, and up to 750° Fahrenheit, towards the agitating conveyor 108.

The agitating conveyor 108 is unique in that the constant movement of the individual components of the used asphalt material 200, while absorbing radiant and convectional heat 204 from both the conveyor heating member 206a, 206b, 206c beneath and the radiant heating coil above, enables the gradual, uniform heating of the entire surface of the granules that make up the used asphalt material 200.

Consequently, the uniform heating of the used asphalt material 200 along the length of the agitating conveyor 108 inhibits moisture from surging from the used asphalt material 200, and also helps to maintain the integrity of the subsequently formed rejuvenated asphalt. In this manner, surges of steam do not disrupt the recycling process. Also, the used asphalt material 200 is less likely to fracture from violent surges of moisture loss.

Looking again at FIG. 3, after discharge from the outlet portion 106 of the heating chamber 102, the used asphalt material 200 enters a rejuvenating chamber 304, such as a pug mill. The rejuvenating chamber 304 is configured to mix the used asphalt material 200 with a rejuvenating composition, so as to make the used asphalt material 200 more supple and acceptable for use. Specifically, the asphalt cement component of the used asphalt material 200 is made more elastic and flexible, so as to bring the asphalt cement back to its original state when it was originally manufactured.

In some embodiments, the rejuvenating chamber 304 may include a liner that receives and retains heat within the rejuvenating chamber 304. In one embodiment, the liner may be heated to about 325° Fahrenheit, so as to help maintain a constant temperature for the used asphalt material 200 after leaving the heating chamber 102. By maintaining the used asphalt material 200 at about 325° Fahrenheit in the rejuvenating chamber 304, the rejuvenating composition may be more efficaciously absorbed by the used asphalt material 200.

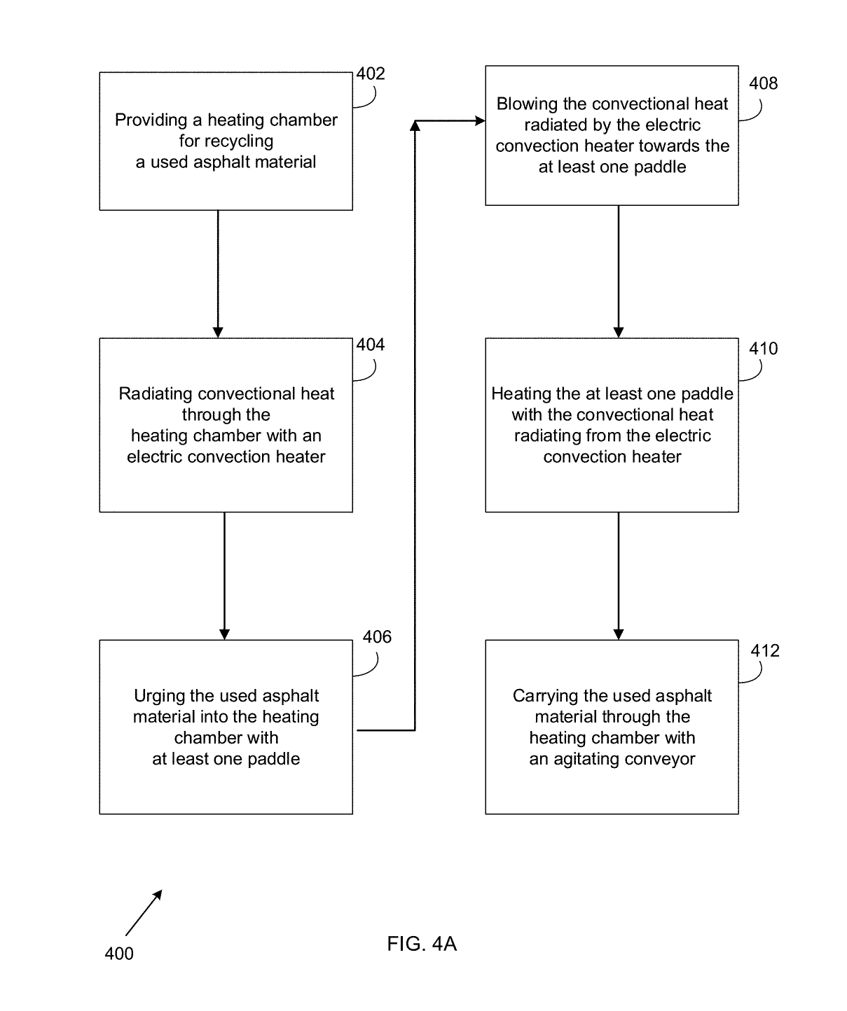

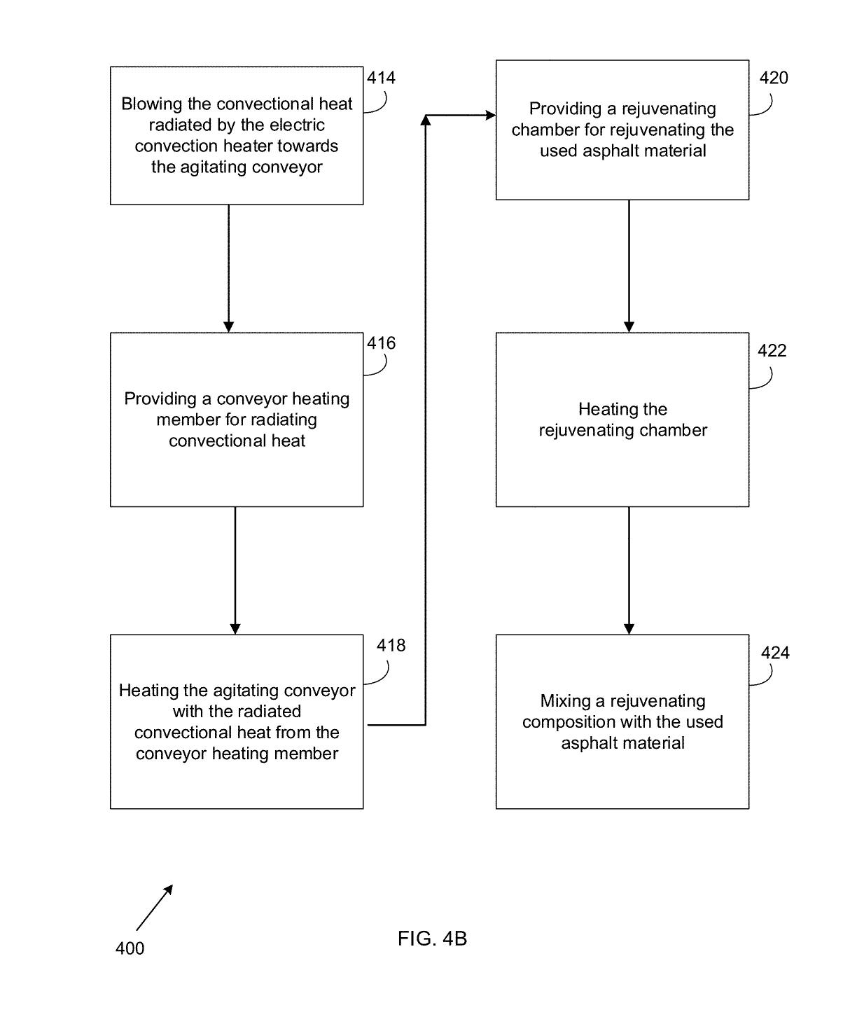

FIGS. 4A and 4B illustrate a flowchart diagram of an exemplary method 400 for maneuvering an exemplary guide wire through a cavity. The method 400 for recycling used asphalt material 200 with radiant and convectional heat 204 is configured to recycle used asphalt material 200, such as reclaimed asphalt pavement, by uniformly and gradually applying radiant and convectional heat 204 to the used asphalt material 200. The method 400 further employs a radiant heating coil 202 that radiates a controlled amount of radiant and convection heat, at about 325 degrees, and up to 750 degrees Fahrenheit. At least one blower 208 blows through the radiant heating coil 202 to create the convectional heat 204.

In some embodiments, the method 400 may utilize an agitating conveyor 108 that simultaneously carries the used asphalt material 200 while it is being heated. The agitating conveyor 108 has a radiant heated conveyor floor that comprises depressions that work to agitate and manipulate the used asphalt material 200. The uniform heating of the used asphalt material 200 inhibits moisture from surging from the used asphalt material 200 and maintains integrity of the subsequently formed rejuvenated asphalt. A rejuvenating chamber 304 mixes the used asphalt material with a rejuvenating composition.

The method 400 may include an initial Step 402 of providing a heating chamber 102 for recycling a used asphalt material 200. The heating chamber 102 may be insulated and designed in such a manner that convectional heat 204 is conserved, radiated, and reused efficiently. For example, the heating chamber 102 may include an insulated, closed vessel that retains the convectional heat 204 and has an exhaust to regulate the release of excess heat. In one embodiment, the heating chamber 102 comprises an intake portion 104 and an outlet portion 106.

The method 400 may further comprise a Step 404 of radiating convectional heat 204 through the heating chamber 102 with a radiant heating coil 202. The radiant heating coil 202 generates the radiant and convectional heat 204 throughout the heating chamber 102. The radiant heating coil 202 is configured to apply a controlled amount of radiant and convectional heat 204, at a precise temperature level, with extended exposure time throughout the entire surface of the used asphalt material 200.

A Step 406 includes urging the used asphalt material 200 into the heating chamber 102 with at least one paddle 114a, 114b, 114c. The paddle 114a, 114b, 114c urges the used asphalt material 200 onto the reception end 112, or even in a middle section of the agitating conveyor 108. Through urging by the paddle 114a, 114b, 114c and rotation of the agitating conveyor 108, the used asphalt material 200 is carried to the discharge end 110 of the agitating conveyor 108 for unloading.

In some embodiments, a Step 408 comprises blowing the convectional heat 204 radiated by the radiant heating coil 202 towards the at least one paddle 114a, 114b, 114c. The at least one blower 208 is configured to blow the convectional heat 204 from the radiant heating coil 202 towards, and around the used asphalt material 200. In some embodiments, the blower 208 may be disposed in a spaced-apart relationship directly over, and along the sides of the agitating conveyor 108. The velocity of the heated air flow from the blower 208 may be adjusted.

A Step 410 includes heating the at least one paddle 114a, 114b, 114c with the convectional heat 204 radiating from the radiant heating coil 202. While urging the used asphalt material 200 onto the agitating conveyor 108, the paddle 114a, 114b, 114c is heated to about 325° through convectional heating from the radiant heating coil 202, or in some embodiments, independent paddle convectional heaters. In yet another embodiment, the paddle 114a, 114b, 114c is heated with electric radiant and convectional heat 204 while urging the used asphalt material 200 onto the agitating conveyor 108.

In some embodiments, a Step 412 may include carrying the used asphalt material 200 through the heating chamber 102 with an agitating conveyor 108. While carrying the used asphalt material 200, the unique configuration of the agitating conveyor 108 works to tumble and manipulate the used asphalt material 200 as it is being heated. The agitating conveyor 108 may include a slotted conveyor belt having a surface covered with a plurality of concave dimples.

A Step 414 comprises blowing the convectional heat 204 radiated by the radiant heating coil 202 towards the agitating conveyor 108. The blower 208 performs this heat radiating function. A Step 416 includes providing a conveyor heating member 206a, 206b, 206c for radiating convectional heat 204 to the agitating conveyor 108. The method 400 may further include a Step 418 of heating the agitating conveyor 108 with the radiated convectional heat 204 from the conveyor heating member 206a, 206b, 206c. The conveyor heating member 206a, 206b, 206c may be electrical and adjacent to the agitating conveyor 108, such that the convectional heat 204 efficiently and uniformly transfers to the used asphalt material 200 being carried on the agitating conveyor 108.

A Step 420 comprises providing a rejuvenating chamber 304 for rejuvenating the used asphalt material 200. After discharge from the outlet portion 106 of the heating chamber 102, the used asphalt material 200 enters a rejuvenating chamber 304, such as a pug mill. The rejuvenating chamber 304 is configured to mix the used asphalt material 200 with a rejuvenating composition, so as to make the used asphalt material 200 more supple and acceptable for use.

A Step 422 may include heating the rejuvenating chamber 304. The rejuvenating chamber 304 is heated to maintain the used asphalt material 200 at the 325° Fahrenheit desired temperature. A final Step 424 comprises mixing a rejuvenating composition with the used asphalt material 200. The rejuvenating composition works with the heat to achieve the desired final product of asphalt material.

These and other advantages of the invention will be further understood and appreciated by those skilled in the art by reference to the following written specification, claims and appended drawings.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What I claim is:

1. A system for recycling used asphalt material with radiant and convectional heat, the system comprising:
a heating chamber, the heating chamber comprising an intake portion and an outlet portion, the heating chamber configured to retain convectional heat;
an agitating conveyor, the agitating conveyor comprising a reception end and a discharge end, the agitating conveyor configured to enable carrying a used asphalt material from the intake portion to the outlet portion of the heating chamber, the agitating conveyor further comprising a plurality of depressions, the plurality of depressions configured to help agitate and tumble the used asphalt material while being carried to the outlet portion of the heating chamber;
a conveyor heating member, the conveyor heating member disposed proximally to the agitating conveyor, the conveyor heating member configured to emit convectional heat of about 325 degrees Fahrenheit,
whereby the convectional heat from the conveyor heating member at least partially transfers to the used asphalt material;
a radiant heating coil, the radiant heating coil configured to radiate a generally uniform convectional heat of about 325 degrees Fahrenheit;
at least one paddle, the at least one paddle configured to urge the used asphalt material towards the reception end of the agitating conveyor;
at least one blower, the at least one blower configured to blow the generally uniform convectional heat radiated by the radiant heating coil towards the agitating conveyor and the at least one paddle, the at least one blower further configured to recover convectional heat from the heating chamber,
whereby the convectional heat enables heating of the used asphalt material and the at least one paddle at about 325 degrees Fahrenheit,
whereby the used asphalt material is maintained at about 325 degrees Fahrenheit while in the heating chamber,
whereby the used asphalt material releases moisture in a controlled, uniform manner at about 325 degrees Fahrenheit; and
a rejuvenating chamber, the rejuvenating chamber configured to enable reception of the used asphalt material from the discharge end of the agitating conveyor, the rejuvenating chamber further configured to enable reception of a rejuvenating composition, the rejuvenating chamber comprising a liner, the liner configured to be heated to about 325 degrees Fahrenheit,
whereby the rejuvenating composition enhances the used asphalt material,
whereby maintaining the used asphalt material at about 325 degrees Fahrenheit enhances absorption of the rejuvenating composition.

2. The system of claim 1, wherein the agitating conveyor comprises a slotted conveyor belt.

3. The system of claim 1, wherein the agitating conveyor comprises a conveyor floor.

4. The system of claim 1, further including a chain.

5. The system of claim 4, wherein the chain is configured to rotate the agitating conveyor.

6. The system of claim 1, wherein the agitating conveyor is about four feet wide.

7. The system of claim 1, wherein the at least one paddle comprises about ninety paddles.

8. The system of claim 1, wherein the at least one paddle is configured in a generally concave shape.

9. The system of claim 1, wherein the plurality of depressions comprises a concave dimple.

10. The system of claim 1, wherein the rejuvenating chamber comprises a pug mill.

11. A system for recycling used asphalt material with radiant and convectional heat, the system comprising:
a heating chamber, the heating chamber comprising an intake portion and an outlet portion, the heating chamber configured to retain convectional heat;
an agitating conveyor, the agitating conveyor comprising a reception end and a discharge end, the agitating conveyor configured to enable carrying a used asphalt material from the intake portion to the outlet portion of the heating chamber, the agitating conveyor further comprising a plurality of depressions, the plurality of depressions configured to help agitate and tumble the used asphalt material while being carried to the outlet portion of the heating chamber;
a conveyor heating member, the conveyor heating member disposed proximally to the agitating conveyor, the conveyor heating member configured to emit convectional heat of up to 750 degrees Fahrenheit,
whereby the convectional heat from the conveyor heating member at least partially transfers to the used asphalt material;
a radiant heating coil, the radiant heating coil configured to radiate a generally uniform convectional heat of up to 750 degrees Fahrenheit;
at least one paddle, the at least one paddle configured to urge the used asphalt material towards the reception end of the agitating conveyor;
at least one blower, the at least one blower configured to blow the generally uniform convectional heat radiated by the radiant heating coil towards the agitating conveyor and the at least one paddle, the at least one blower further configured to recover convectional heat from the heating chamber,
whereby the convectional heat enables heating of the used asphalt material and the at least one paddle up to 750 degrees Fahrenheit,
whereby the convectional heat further enables optimal thermal absorption and heat exchange with the used asphalt material,
whereby the used asphalt material is maintained up to 750 degrees Fahrenheit while in the heating chamber,
whereby the used asphalt material releases moisture in a controlled, uniform manner up to 750 degrees Fahrenheit; and
a rejuvenating chamber, the rejuvenating chamber configured to enable reception of the used asphalt material from the discharge end of the agitating conveyor, the rejuvenating chamber further configured to enable reception of a rejuvenating composition, the rejuvenating chamber comprising a liner, the liner configured to be heated up to 750 degrees Fahrenheit,
whereby the rejuvenating composition enhances the used asphalt material,
whereby maintaining the used asphalt material up to 750 degrees Fahrenheit enhances absorption of the rejuvenating composition.

12. The system of claim 11, wherein the at least one paddle comprises about ninety paddles.

13. The system of claim 11, wherein the agitating conveyor comprises a slotted conveyor belt.

14. The system of claim 11, wherein the agitating conveyor comprises a conveyor floor.

15. The system of claim 11, further including a chain.

16. The system of claim 15, wherein the chain is configured to rotate the agitating conveyor.

17. A method for recycling used asphalt material with radiant and convectional heat, the system comprising:
providing a heating chamber for recycling a used asphalt material;
radiating convectional heat through the heating chamber with a radiant heating coil;
urging the used asphalt material into the heating chamber with at least one paddle;
blowing the convectional heat radiated by the radiant heating coil towards the at least one paddle;
heating the at least one paddle with the convectional heat radiating from the radiant heating coil;
carrying the used asphalt material through the heating chamber with an agitating conveyor;
blowing the convectional heat radiated by the radiant heating coil towards the agitating conveyor;
providing a conveyor heating member for radiating convectional heat to the agitating conveyor;
heating the agitating conveyor with the radiated convectional heat from the conveyor heating member;
providing a rejuvenating chamber for rejuvenating the used asphalt material;
heating the rejuvenating chamber; and
mixing a rejuvenating composition with the used asphalt material.

18. The method of claim 17, further including a step of capturing, with the at least one blower, the convectional heat for reuse.

19. The method of claim 17, wherein the step of radiating convectional heat through the heating chamber with a radiant heating coil, further includes radiating convectional heat at about 325 degrees Fahrenheit.

20. The method of claim 17, wherein the step of radiating convectional heat through the heating chamber with a radiant heating coil, further includes radiating convectional heat up to 750 degrees Fahrenheit.
